(19) United States
(12) Patent Application Publication
(10) Pub. No.: US 2023/0357075 A1
(43) Pub. Date: Nov. 9, 2023

(54) FLUORITE SYNTHETIC STONES AND METHOD OF MAKING FLUORITE SYNTHETIC STONES

(71) Applicant: MEXICHEM FLUOR S.A. DE C.V., SAN LUIS POTOSI (MX)

(72) Inventors: Luis Angel Gutierrez L., San Luis Potosi (MX); Gabriel A. García Martínez, San Luis Potosi (MX); Iván Martínez Costa, San Luis Potosi (MX); Rosa Rivera Martínez, San Luis Potosi (MX); Paloma Venegas Rodríguez, San Luis Potosi (MX); Carlos Cárdenas Daw, San Luis Potosi (MX)

(73) Assignee: MEXICHEM FLUOR S.A. DE C.V., SAN LUIS POTOSI (MX)

(21) Appl. No.: 18/141,157

(22) Filed: Apr. 28, 2023

Related U.S. Application Data
(60) Provisional application No. 63/339,019, filed on May 6, 2022.

(51) Int. Cl. C21C 7/064; C03C 1/02; C21C 7/00; C03C 14/00

(52) U.S. Cl. CPC C03C 14/006; C03C 1/026; C21C 7/0087; C21C 7/0645; C03C 2214/16

(57) ABSTRACT

A fluorite synthetic stone comprises: (a) a glass matrix comprising Ca, Si and O, and having a predetermined weight ratio of Ca to Si; and (b) CaF₂ crystals dispersed in the glass matrix at a concentration of at least about 70 wt.%. A method of making fluorite synthetic stones includes formulating a particulate mixture comprising: CaF₂ crystals at a concentration of at least about 70 wt.%; and an excipient having a predetermined weight ratio of Ca to Si. Aggregates are prepared from the particulate mixture. The aggregates are heat treated to form a plurality of fluorite synthetic stones, where each synthetic stone comprises: a glass matrix comprising Ca, Si and O; and CaF₂ crystals dispersed in the glass matrix at a concentration of at least about 70 wt.%.

### RELATED APPLICATION

The present patent document claims the benefit of priority under 35 U.S.C. 119(e) to U.S. Provisional Pat. Application No. 63/339,019, which was filed on May 6, 2022, and is hereby incorporated by reference in its entirety.

### TECHNICAL FIELD

The present disclosure is related generally to slag additives for the steel industry and more particularly to fluorite synthetic stones.

### BACKGROUND

The refining process in steel production is by injection of oxygen and is an intensive process. Reactions occur in the hot metal but some others at the slag-metal interface, or the slag-gas interface. The interaction of the slag and the gas produces a “foam.” Viscosity controls the properties of the foam. Secondary refinement of the steel aims to reduce carbon, sulfur and phosphorus impurities to very low levels. The slag floats on the molten metal, protecting the surface from oxidation and absorbing impurities dissolved in the molten metal. Typical compositions of slags are high in CaO with some additions of MgO. Fluorospar, a mineral including CaF₂, may be employed as a slag additive or flux to enhance removal of impurities such as sulfur and phosphorus from the molten metal and/or to enhance fluidity of the slag. However, reliance on fluorospar, which is a natural stone product with an uncontrolled supply, may put supply chains in jeopardy.

### BRIEF DESCRIPTION OF THE DRAWINGS

FIG. 1 is a flow chart of an exemplary method to produce fluorite synthetic stones.

FIG. 2 is a photograph of exemplary fluorite synthetic stones.

FIGS. 3A and 3B show portions of x-ray diffraction patterns for aggregates (green samples) and synthetic stones (sintered samples), respectively, prepared from a blend of beneficiated fluorospar and slimes having a Ca to Si weight ratio of about 2:1.

### DETAILED DESCRIPTION

Described in this disclosure is a fluorite synthetic stone that has a high CaF₂ content and stone-like characteristics for use in steelmaking and other applications. Fabricated using a novel method that includes formulation, aggregation, and sintering, the fluorite synthetic stone has a composite structure including CaF₂ crystals at a concentration of at least about 70 wt.% (and typically higher) dispersed in a glass matrix comprising Ca, Si, and O. When prepared under suitable process conditions with a predetermined weight ratio of Ca to Si, the fluorite synthetic stone may include an interparticle (matrix) phase surrounding the CaF₂ crystals that is believed to contribute to the exceptional properties of the synthetic stone product. For example, the synthetic stone may exhibit wear resistance, compressive strength and/or water absorption properties comparable or superior to those of natural stone. The fabrication process may be controlled such that the fluorite synthetic stone contains little to no carbon, sulfur, and/or phosphorus, impurities that may be detrimental to steelmaking. The synthetic stones may be added to a steel-making furnace containing molten steel and slag for the purpose of reducing the viscosity of the slag and/or increasing the capacity of the slag to remove impurities (e.g., sulfur) from the molten steel. Typically, 2-10 kg of the fluorite synthetic stones may be added per ton of steel.

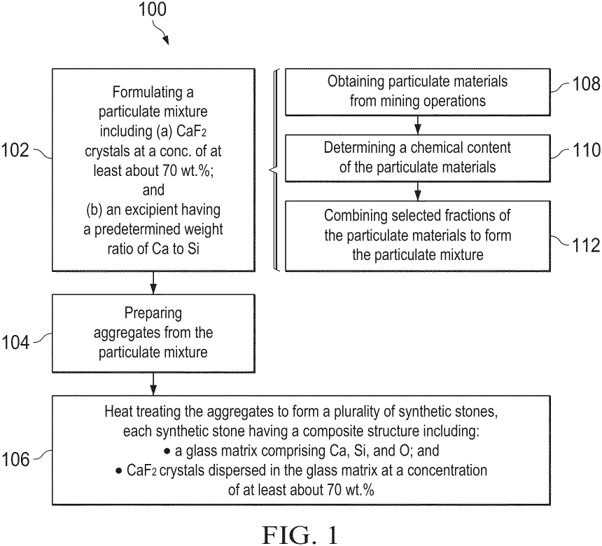

Before the fluorite synthetic stone is described in detail, a method of making the synthetic stone is explained in reference to FIG. 1. It is noted that the terms “fluorite synthetic stone” and “synthetic stone” are used alternately throughout the disclosure. Broadly speaking, the method 100 includes formulating 102 a particulate mixture including (a) CaF₂ crystals at a concentration of at least about 70 wt.%, and (b) an excipient having a predetermined weight ratio of Ca to Si. Aggregates are then prepared 104 from the particulate mixture, and the aggregates are heat treated 106 to form a plurality of fluorite synthetic stones, where each fluorite synthetic stone has a composite structure including: a glass matrix comprising Ca, Si, and O; and CaF₂ crystals dispersed in the glass matrix at a concentration of at least about 70 wt.%. More particularly, the glass matrix may include Ca and Si at the predetermined weight ratio, as discussed below.

Formulation 102 of the particulate mixture may include multiple steps, as indicated in FIG. 1. First, particulate materials may be obtained 108 from mining operations. This may entail collecting fluorospar and low-grade materials such as sludge, tailings and slimes from mining operations, followed by drying and/or sieving, as needed, to obtain the particulate materials. Various grades of fluorospar may be suitable. For example, the fluorospar may be acid-grade or beneficiated fluorospar which has been concentrated to 97%+ CaF₂. Alternatively, non-compliant acid-grade fluorospar, which includes about 90% CaF₂, may be used.

The chemical content of the particulate materials is then determined 110. Of particular interest is the concentration of Ca, F, and Si, which may be used to estimate the amount of CaF₂, SiO₂ CaO and/or CaCO₃ in the particulate materials. A chemical analysis method such as x-ray fluorescence (XRF), which is capable of determining concentrations of elements heavier than oxygen when suitable instruments are used, may be employed for determining 110 the chemical content.

Once the chemical content is known, selected fractions of the particulate materials are combined 112 to form the particulate mixture described above. It is understood that the excipient includes Ca, Si, and O, with little to no undesired impurities, such as S and P. Preferably, the excipient includes S at a concentration of less than about 0.1 wt.% and/or is devoid of S; also or alternatively, the excipient preferably includes P at a concentration of less than about 0.1 wt.% and/or is devoid of P. Any C present in the excipient is substantially or completely removed during a downstream processing step (heat treatment). For some applications, where it may be beneficial to have additional ceramic constituents in the fluorite synthetic stone product, one or more additional particulate materials, such as Al₂O₃ and/or MgO, may be added to the particulate mixture in desired amounts at this point in the process.

Aggregates are then prepared 104 from the particulate mixture, e.g., by mixing a binder into the particulate mixture, followed by granulation, compaction, extrusion, pelletizing, briquetting, and/or another shaping method to form the aggregates. For example, granulation to form the aggregates may be carried out in a rotating drum/disc, or a briquetting machine or extruder may be employed. The size of the aggregates may range from a few millimeters to a few centimeters in linear size (width or diameter). The binder added to the particulate mixture may comprise an organic binder, an inorganic binder, and/or an aqueous binder. In one example, the binder may comprise a sodium silicate solution (water glass). Typically, the binder is added to the particulate mixture in an amount from about 0.5 wt.% to about 10 wt.%, or from about 5 wt.% to about 7 wt.%.

In some examples, the aggregates are dried to improve their green strength before further processing. Drying of the aggregates may comprise evaporating or curing the binder, and may be carried out passively (e.g., in air) or actively (e.g., in a furnace at a suitable temperature).

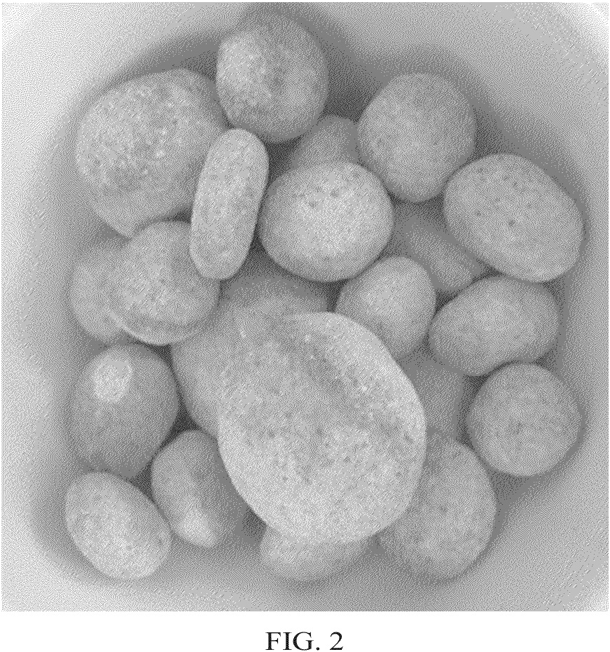

In order to effect sintering and decarburization, the aggregates undergo a heat treatment 106. Formed in the heat treatment 106 are a plurality of sintered synthetic stones, as shown for example in FIG. 2, where each fluorite synthetic stone includes CaF₂ crystals at a concentration of at least about 70 wt.% dispersed in a glass matrix comprising Ca, Si, and O. More typically, the concentration of the CaF₂ crystals is 80 wt.% or higher, or 90 wt.% or higher. In some examples, the CaF₂ crystals may be present at a concentration of at least about 92 wt.%, or at least about 94 wt.%, and/or as high as 96 wt.%. Under the conditions of the heat treatment, the excipient having the predetermined ratio of Ca to Si forms the glass matrix that at least partly surrounds the CaF₂ crystals. In addition, CaCO₃ present in the excipient may decompose into CO₂ gas and CaO, which may combine with silicon. The heat treatment may take place at a temperature of at least about 950° C., or at least about 1000° C. Typically the temperature is no higher than about 1200° C. and/or is below the melting temperature of CaF₂. The time duration for the heat treatment may be at least about 20 minutes, at least about 40 minutes, or at least about 60 minutes, and/or up to about 120 minutes. The heat treatment may take place until CaCOs, CaO, and/or SiO₂ crystals are no longer detectible by x-ray diffraction (XRD), and/or the carbon content is less than 1 wt.%. In some examples, as discussed below, the excipient may include excess Si, and thus the SiO₂ peaks may not completely disappear from the XRD pattern. Preferably, the CaCO₃ and/or the CaO peaks fully disappear. The heat treatment may entail furnace heating or microwave heating. The heat treatment may be carried out in air. In the latter case, prior to carrying out the microwave heating, the aggregates may be embedded in a susceptor material such as carbon.

The glass matrix of the fluorite synthetic stone may include one or more silicates and/or oxides, such as a Ca-Si-O compound (e.g., Ca₂SiO₃ and/or Ca₂SiO₄ (2CaO·SiO₂)), a Si-O compound (e.g., SiO₂) and/or a Ca-O compound (e.g., CaO). The glass matrix may be partially or fully amorphous (noncrystalline). Accordingly, in some examples the glass matrix may be at least partially crystalline. It is also contemplated that, under some processing conditions, the glass matrix may be fully crystallized. Preferably, the synthetic stone includes less than about 1 wt.% of free CaO (that is, CaO that is not part of a Ca-Si-O compound) and other water-absorbing phases, to reduce water absorption by the synthetic stone. The glass matrix may be partially fluorinated. Due to decarburization during the heat treatment, the amount of carbon in the sintered synthetic stone may be less than about 1 wt.%, less than about 0.1 wt.%, and/or preferably below the detectability limits of the measurement method.

To achieve the desired glass matrix, the predetermined weight ratio of Ca to Si in the excipient is preferably greater than 1, e.g., from about 2:1 to about 4:1. At Ca to Si ratios within this range, the fluorite synthetic stone produced upon sintering may comprise an amorphous interparticle phase that at least partly surrounds the CaF₂ crystals. This amorphous interparticle phase - i.e., the glass matrix - may include Ca and Si in the predetermined weight ratio (e.g., greater than 1, or from about 2:1 to about 4:1) and may contribute to the exceptional mechanical integrity and low water absorption of the fluorite synthetic stone.

For some applications, the excipient may include a Ca to Si weight ratio equal to or less than 1 (e.g., from 0.4:1 to 1:1). At lower Ca to Si ratios, the fluorite synthetic stone may include, in addition to the CaF₂ crystals, Si-containing crystalline phases such as SiO₂ dispersed in the glass matrix. While higher amounts of Si (or lower Ca to Si weight ratios) may hinder sintering, the resulting fluorite synthetic stone may have increased values of compressive strength due to the presence of the Si-containing crystalline phases. At lower Si contents (e.g., Ca:Si > 4:1), water absorption of the fluorite synthetic stone produced by the method may be detrimentally increased due to free CaO remaining in the sintered stone. As indicated above, the fluorite synthetic stone preferably includes a limited amount of free CaO.

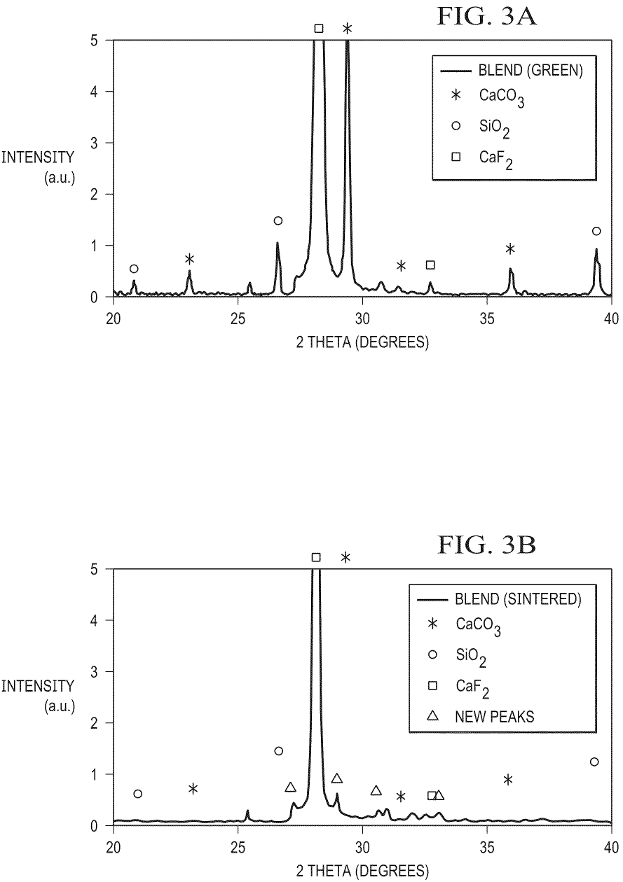

FIGS. 3A and 3B show portions of x-ray diffraction patterns for aggregates (green samples) and synthetic stones (sintered samples), respectively, prepared from a blend of beneficiated fluorospar and slimes having a Ca to Si weight ratio of about 2. The sintered samples were heat treated at 1200° C. for 60 min. As can be seen, peaks in FIG. 3A corresponding to crystalline SiO₂ and CaCO₃ are not present in FIG. 3B, indicating amorphization during the heat treatment. In addition, new low intensity peaks (indicated by the arrows) that may correspond to a glassy silicate phase (e.g., CaSiO₃) are observed in FIG. 3B.

The CaF₂ crystals in the fluorite synthetic stone may have a linear size (e.g., a length and/or width) in a range from about 500 nm to about 500 microns, or more typically from about 1 micron to about 150 microns. The CaF₂ crystals may have a multi-modal size distribution in the glass matrix. As discussed above in regard to the Ca:Si ratio, the synthetic stone may further include, in some examples, SiO₂ crystals dispersed in the glass matrix. Also or alternatively, the synthetic stone may include additional ceramic constituents such as Al₂O₃ crystals and/or MgO crystals dispersed in the glass matrix. These optional additional ceramic crystals may have a linear size in the ranges set forth above for the CaF₂ crystals, and/or they may have a multimodal size distribution. Due to the elevated temperatures of the heat treatment, the binder present in the aggregates may be pyrolyzed or evaporated, and thus the fluorite synthetic stone may be devoid of a binder (e.g., an organic or aqueous binder). In other examples, such as when an inorganic binder is used, the binder may undergo a chemical transformation during the heat treatment and remain in the synthetic stone product in a transformed chemical state.

The porosity in the aggregates is significantly reduced during the heat treatment and the resulting sintered synthetic stone may include primarily or exclusively closed pores. The fluorite synthetic stone may have a density in a range from about 2.2 g/cm³ to about 3 g/cm³, as determined by buoyancy testing based on the Archimedes principle. The sintered stone may have a nominal linear size (width or diameter) in a range from a few millimeters to a few centimeters.

The fluorite synthetic stone prepared as described herein may exhibit characteristics and properties on par with or superior to natural stone. For example, the synthetic stone may exhibit a high resistance to attrition when subjected to a rotating drum test for 60 minutes; mass loss from the sample may be about 7 wt.% or less. Preliminary experiments reveal that the synthetic stone can withstand an average compressive force of at least about 1330 N prior to fracture. The synthetic stone may also or alternatively exhibit a water absorption of no more than about 0.1 wt.% after six days in a humidity chamber (>90% relative humidity).

The subject-matter of the disclosure may also relate, among others, to the following aspects:

A first aspect relates to a fluorite synthetic stone comprising: a glass matrix comprising Ca, Si and O and having a predetermined weight ratio of Ca to Si; and CaF₂ crystals dispersed in the glass matrix at a concentration of at least about 70 wt.%.

A second aspect relates to the fluorite synthetic stone of the first aspect, wherein the predetermined weight ratio of Ca to Si is greater than 1, and/or wherein the predetermined weight ratio of Ca to Si is from about 2:1 to about 4:1.

A third aspect relates to the fluorite synthetic stone of any preceding aspect, wherein the predetermined weight ratio of Ca to Si is less than 1.

A fourth aspect relates to the fluorite synthetic stone of any preceding aspect, wherein the concentration is at least about 80 wt.%, at least about 90 wt.%, at least about 92 wt.%, or at least about 94 wt.%, and/or as high as about 96 wt.%.

A fifth aspect relates to the fluorite synthetic stone of any preceding aspect, wherein the glass matrix comprises one or more silicates and/or oxides.

A sixth aspect relates to the fluorite synthetic stone of the fifth aspect, wherein the glass matrix comprises a Ca-Si-O compound selected from the group consisting of Ca₂SiO₃ and Ca₂SiO₄ (2CaO·SiO₂).

A seventh aspect relates to the fluorite synthetic stone of any preceding aspect, wherein the glass matrix is partially fluorinated.

An eighth aspect relates to the fluorite synthetic stone of any preceding aspect, including free CaO at a concentration less than about 1 wt.%.

A ninth aspect relates to the fluorite synthetic stone of any preceding aspect, wherein the CaF₂ crystals have a linear size in a range from about 500 nm to about 500 microns.

A tenth aspect relates to the fluorite synthetic stone of the ninth aspect, wherein the linear size is in the range from about 1 micron to about 150 microns.

An eleventh aspect relates to the fluorite synthetic stone of any preceding aspect, wherein the CaF₂ crystals have a multi-modal size distribution.

A twelfth aspect relates to the fluorite synthetic stone of any preceding aspect, further comprising SiO₂ crystals dispersed in the glass matrix.

A thirteenth aspect relates to the fluorite synthetic stone of any preceding aspect, further comprising Al₂O₃ crystals and/or MgO crystals dispersed in the glass matrix.

A fourteenth aspect relates to the fluorite synthetic stone of any preceding aspect, including C at a concentration less than about 1 wt.% and/or being devoid of C.

A fifteenth aspect relates to the fluorite synthetic stone of any preceding aspect, including CaCO₃ at a concentration less than about 2 wt.% and/or being devoid of CaCO₃.

A sixteenth aspect relates to the fluorite synthetic stone of any preceding aspect, including S at a concentration of less than about 0.1 wt.% and/or being devoid of S.

A seventeenth aspect relates to the fluorite synthetic stone of any preceding aspect, including P at a concentration of less than about 0.1 wt.% and/or being devoid of P.

An eighteenth aspect relates to the fluorite synthetic stone of any preceding aspect, being devoid of a binder.

A nineteenth aspect relates to the fluorite synthetic stone of any preceding aspect, having a density in a range from about 2.2 g/cm³ to about 3 g/cm³, as determined by Archimedes principle buoyancy testing.

A twentieth aspect relates to the fluorite synthetic stone of any preceding aspect, having a high resistance to attrition, wherein, after a sample of the fluorite synthetic stones is subjected to a rotating drum test for 60 minutes, mass loss from the sample is about 7 wt.% or less.

A twenty-first aspect relates to the fluorite synthetic stone of any preceding aspect, sustaining an average compressive force of at least about 1330 N prior to failure.

A twenty-second aspect relates to the fluorite synthetic stone of any preceding aspect, exhibiting an absorption of water of no more than about 0.1 wt.% after six days in a humidity chamber (>90% relative humidity).

A twenty-third aspect relates to the fluorite synthetic stone of any preceding aspect, having a nominal size in a range from a few millimeters to a few centimeters.

A twenty-fourth aspect relates to a method of using the fluorite synthetic stone of any preceding aspect, the method comprising: adding a plurality of the fluorite synthetic stones to a steel-making furnace containing slag and molten steel.

A twenty-fifth aspect relates to the method of the preceding aspect, wherein the addition of the fluorite synthetic stones reduces a viscosity of the slag.

A twenty-sixth aspect relates to the method of any preceding aspect, wherein the addition of the fluorite synthetic stones increases a capacity of the slag to remove sulfur from the molten steel.

A twenty-seventh aspect relates to a method of making fluorite synthetic stones, the method comprising: formulating a particulate mixture including: CaF₂ crystals at a concentration of at least about 70 wt.%; and an excipient having a predetermined weight ratio of Ca to Si; preparing aggregates from the particulate mixture; and heat treating the aggregates to form a plurality of fluorite synthetic stones, each fluorite synthetic stone comprising: a glass matrix comprising Ca, Si and O; and CaF₂ crystals dispersed in the glass matrix at a concentration of at least about 70 wt.%.

A twenty-eighth aspect relates to the method of the preceding aspect, wherein formulating the particulate mixture comprises: obtaining particulate materials from mining operations; determining a chemical content of the particulate materials; and combining selected fractions of the particulate materials to form the particulate mixture.

A twenty-ninth aspect relates to the method of any preceding aspect, wherein determining the chemical content of the particulate materials comprises determining a content of Ca, F, and Si.

A thirtieth aspect relates to the method of the preceding aspect, wherein determining the chemical content of the particulate materials further comprises estimating an amount of CaF₂, SiO₂, CaO, and/or CaCO₃.

A thirty-first aspect relates to the method of any preceding aspect, wherein determining the chemical content of the particulate materials comprises conducting x-ray fluorescence analysis on the particulate materials.

A thirty-second aspect relates to the method of any preceding aspect, further comprising, after formulating the particulate mixture, adding one or more additional particulate materials to the particulate mixture.

A thirty-third aspect relates ot the method of the preceding aspect, wherein the one or more additional particulate materials are selected from the group consisting of Al₂O₃ and MgO.

A thirty-fourth aspect relates to the method of any preceding aspect, wherein the predetermined weight ratio is greater than 1.

A thirty-fifth aspect relates to the method of any preceding aspect, wherein the predetermined weight ratio is from about 2:1 to about 4:1.

A thirty-sixth aspect relates to the method of any preceding aspect, wherein the predetermined weight ratio is less than 1.

A thirty-seventh aspect relates to the method of any preceding aspect, wherein preparing the aggregates comprises mixing a binder into the particulate mixture, the binder being selected from the group consisting of: an organic binder, an inorganic binder, and an aqueous binder.

A thirty-eighth aspect relates to the method of the preceding aspect, wherein the binder comprises a sodium silicate solution (water glass).

A thirty-ninth aspect relates to the method of any preceding aspect, wherein the binder is added in an amount from about 2 wt.% to about 10 wt.%, or from about 5 wt.% to about 7 wt.%.

A fortieth aspect relates to the method of any preceding aspect, wherein preparing the aggregates comprises granulation, compaction, extrusion, pelletizing, and/or briquetting.

A forty-first aspect relates to the method of any preceding aspect, further comprising, prior to heat treating the aggregates, drying the aggregates to improve green strength.

A forty-second aspect relates to the method of any preceding aspect, wherein the drying comprises evaporating or curing the binder.

A forty-third aspect relates to the method of any preceding aspect, wherein the aggregates are heat treated at a temperature of at least about 950° C., or at least about 1000° C., and/or no higher than about 1200° C.

A forty-fourth aspect relates to the method of any preceding aspect, wherein the aggregates are heat treated for a time duration of at least about 20 minutes, at least about 40 minutes, at least about 60 minutes, and/or up to about 120 minutes.

A forty-fifth aspect relates to the method of any preceding aspect, wherein the aggregates are heated treated until CaCOs, CaO, and/or SiO₂ crystals are no longer detectible by x-ray diffraction.

A forty-sixth aspect relates to the method of any preceding aspect, wherein the heat treating comprises furnace heating or microwave heating.

A forty-seventh aspect relates to the method of the preceding aspect, wherein, prior to carrying out the microwave heating, the aggregate is embedded in a susceptor material.

A forty-eighth aspect relates to the method of any preceding aspect, wherein the glass matrix comprises one or more silicates and/or oxides.

A forty-ninth aspect relates to the method of any preceding aspect, wherein the glass matrix comprises a Ca-Si-O compound selected from the group consisting of Ca₂SiO₃ and Ca₂SiO₄ (2CaO·SiO₂).

A fiftieth aspect relates to the method of any preceding aspect, wherein the glass matrix is partially fluorinated.

A fifty-first aspect relates to the method of any preceding aspect, wherein the glass matrix includes free CaO at a concentration less than about 1 wt.%.

A fifty-second aspect relates to the method of any preceding aspect, wherein the CaF₂ crystals have a linear size in a range from about 500 nm to about 500 microns.

A fifty-third aspect relates to the method of the preceding aspect, wherein the linear size is in the range from about 1 micron to about 150 microns

A fifty-fourth aspect relates to the method of any preceding aspect, wherein the CaF₂ crystals have a multi-modal size distribution.

A fifty-fifth aspect relates to the method of any preceding aspect, wherein each fluorite synthetic stone further comprises SiO₂ crystals dispersed in the glass matrix.

A fifty-sixth aspect relates to the method of any preceding aspect, wherein each fluorite synthetic stone further comprises Al₂O₃ crystals and/or MgO crystals dispersed in the glass matrix.

A fifty-seventh aspect relates to the method of any preceding aspect, wherein the fluorite synthetic stones include C at a concentration less than about 1 wt.% and/or are devoid of C.

A fifty-eighth aspect relates to the method of any preceding aspect, wherein the fluorite synthetic stones include CaCO₃ at a concentration less than about 2 wt.% and/or are devoid of CaCO₃.

A fifty-ninth aspect relates to the method of any preceding aspect, wherein the fluorite synthetic stones include S at a concentration less than about 0.1 wt.% and/or are devoid of S.

A sixtieth aspect relates to the method of any preceding aspect, wherein the fluorite synthetic stones include P at a concentration less than about 0.1 wt.% and/or are devoid of P.

A sixty-first aspect relates to the method of any preceding aspect, wherein the fluorite synthetic stones are devoid of a binder.

A sixty-second aspect relates to the method of any preceding aspect, wherein the fluorite synthetic stones have a density in a range from about 2.2 g/cm³ to about 3 g/cm³, as determined by Archimedes principle buoyancy testing.

A sixty-third aspect relates to the method of any preceding aspect, wherein, after the fluorite synthetic stones are subjected to a rotating drum test for 60 minutes, mass loss from the fluorite synthetic stones is about 7 wt.% or less.

A sixty-fourth aspect relates to the method of any preceding aspect, wherein the fluorite synthetic stones sustain an average compressive force of at least about 1330 N prior to failure.

A sixty-fifth aspect relates to the method of any preceding aspect, wherein the fluorite synthetic stones exhibit an absorption of water of no more than about 0.1 wt.% after six days in a humidity chamber (>90% relative humidity).

A sixty-sixth aspect relates to the method of any preceding aspect, wherein the fluorite synthetic stones have a nominal size in a range from a few millimeters to a few centimeters.

Although the present invention has been described in considerable detail with reference to certain embodiments thereof, other embodiments are possible without departing from the present invention. The spirit and scope of the appended claims should not be limited, therefore, to the description of the preferred embodiments contained herein. All embodiments that come within the meaning of the claims, either literally or by equivalence, are intended to be embraced therein.

Furthermore, the advantages described above are not necessarily the only advantages of the invention, and it is not necessarily expected that all of the described advantages will be achieved with every embodiment of the invention.

1. A fluorite synthetic stone comprising:
a glass matrix comprising Ca, Si and O and having a predetermined weight ratio of Ca to Si; and
CaF₂ crystals dispersed in the glass matrix at a concentration of at least about 70 wt.%.

2. The fluorite synthetic stone of claim 1, wherein the predetermined weight ratio of Ca to Si is greater than 1.

3. The fluorite synthetic stone of claim 2, wherein the predetermined weight ratio of Ca to Si is from about 2:1 to about 4:1.

4. The fluorite synthetic stone of claim 1, wherein the predetermined weight ratio of Ca to Si is less than 1.

5. The fluorite synthetic stone of claim 1, wherein the glass matrix comprises a Ca-Si-O compound selected from the group consisting of Ca₂SiO₃ and Ca₂SiO₄ (2CaO·SiO₂).

6. The fluorite synthetic stone of claim 1, wherein the glass matrix is partially fluorinated.

7. The fluorite synthetic stone of claim 1, including free CaO at a concentration less than about 1 wt.%.

8. The fluorite synthetic stone of claim 1, wherein the CaF₂ crystals have a linear size in a range from about 500 nm to about 500 microns.

9. The fluorite synthetic stone of claim 1, further comprising SiO₂ crystals dispersed in the glass matrix.

10. The fluorite synthetic stone of claim 1, further comprising Al₂O₃ crystals and/or MgO crystals dispersed in the glass matrix.

11. The fluorite synthetic stone of claim 1 including C at a concentration less than about 1 wt.% and/or being devoid of C,
including CaCOs at a concentration less than about 2 wt.% and/or being devoid of CaCO₃,
including S at a concentration of less than about 0.1 wt.% and/or being devoid of S, and/or
including P at a concentration of less than about 0.1 wt.% and/or being devoid of P.

12. The fluorite synthetic stone of claim 1 being devoid of a binder.

13. A method of using the fluorite synthetic stone of claim 1, the method comprising:
adding a plurality of the fluorite synthetic stones to a steel-making furnace containing slag and molten steel.

14. The method of claim 13, wherein the addition of the fluorite synthetic stones reduces a viscosity of the slag.

15. The method of claim 13, wherein the addition of the fluorite synthetic stones increases a capacity of the slag to remove sulfur from the molten steel.

16. A method of making fluorite synthetic stones, the method comprising:
formulating a particulate mixture including:
CaF₂ crystals at a concentration of at least about 70 wt.%; and
an excipient having a predetermined weight ratio of Ca to Si;
preparing aggregates from the particulate mixture; and
heat treating the aggregates to form a plurality of fluorite synthetic stones, each fluorite synthetic stone comprising: a glass matrix comprising Ca, Si and O; and CaF₂ crystals dispersed in the glass matrix at a concentration of at least about 70 wt.%.

17. The method of claim 16, wherein formulating the particulate mixture comprises:
obtaining particulate materials from mining operations;
determining a chemical content of the particulate materials; and
combining selected fractions of the particulate materials to form the particulate mixture.

18. The method of claim 17, wherein preparing the aggregates comprises granulation, compaction, extrusion, pelletizing, and/or briquetting.

19. The method of claim 17, wherein the aggregates are heat treated at a temperature of at least about 950° C. and no higher than about 1200° C.

20. The method of claim 17, wherein the aggregates are heated treated until CaCO₃, CaO, and/or SiO₂ crystals are no longer detectible by x-ray diffraction.
